(19) United States
(12) Patent Application Publication
(10) Pub. No.: US 2019/0071367 A1
(43) Pub. Date: Mar. 7, 2019

(54) CALCIUM NITRATE FOR REDUCING THE PORE SIZE DISTRIBUTION OF A HARDENED CEMENTITIOUS COMPOSITION AND STEEL REINFORCED CONCRETE HAVING AN ELEVATED RESISTANCE TOWARDS CARBONATION

(71) Applicant: YARA INTERNATIONAL ASA, Oslo (NO)

(72) Inventors: Wolfram Franke, Porsgrunn (NO); Giuseppe Cilluffo, Garbagnate Milanese (IT); Mehrdad Torabzadegan, Skien (NO)

(73) Assignee: YARA INTERNATIONAL ASA, Oslo (NO)

(21) Appl. No.: 15/767,177

(22) PCT Filed: Nov. 10, 2016
(86) PCT No.: PCT/EP2016/077206

§ 371 Date: Apr. 10, 2018

(30) Foreign Application Priority Data
Nov. 10, 2015 (NO) 20151535

(51) Int. Cl. C04B 38/00; C04B 28/04

(52) U.S. Cl. CPC C04B 38/0054; C04B 2111/26; C04B 28/04

(57) ABSTRACT

The invention relates to the use of calcium nitrate to reduce the pore size distribution of a hardened cementitious composition, preferably, a hardened concrete composition, wherein the cementitious (concrete) composition comprises between 1 weight % to 4 weight % of calcium nitrate of the cement content of the cementitious composition, depending on the type of cement. This results in a reduced permeability for the set cementitious (concrete) composition for carbon dioxide (CO₂) and thus an elevated resistance towards carbonation. The invention furthermore relates to a method for producing such a hardened cementitious (concrete) composition and a pourable and curable (wet) concrete composition. The invention also relates to a steel reinforced concrete solid having an elevated resistance towards carbonation and a method for producing a steel reinforced concrete solid having an elevated resistance towards carbonation.

### FIELD OF THE APPLICATION

The application relates to the use of calcium nitrate to modify the pore size distribution of a cementitious composition after being set. The application furthermore relates to a method for producing cementitious composition having a modified pore size distribution after being set. The application also relates to a pourable concrete composition and a steel reinforced concrete solid (=steel reinforced hardened concrete) having an elevated resistance towards carbonation. The application also relates to the use of calcium nitrate as an admixture for a steel reinforced concrete composition to increase the resistance towards carbonation of the steel reinforced hardened concrete. The application finally relates to a method for producing a steel reinforced concrete solid having an elevated resistance towards carbonation of the concrete solid.

### BACKGROUND OF THE APPLICATION

Concrete is a composite construction material composed primarily of aggregate (a), cement (c), and water (w). Typically, ratios of w/c equaling to 0.3 to 0.6 by weight and a/c equaling to 3 to 6 by weight are common. This leads to cement contents of 300 to 500 kg/m³ of concrete. Admixtures are typically added as 0.5 weight % to 5.0 weight % of the cement weight. There are many formulations of added admixtures providing varied properties. The aggregate is generally coarse gravel or crushed rocks such as limestone, or granite, along with a fine aggregate such as sand. The cement is typically of the Portland cement group, but can also be plain, like CEM I, or blended, like CEM II, III or IV, wherein 20 to 50 weight % of the Portland cement is replaced by another semi-reactive material. Other cementitious materials such as fly ash and slag cement serve as a binder for the aggregate. Various chemical admixtures are also added to achieve varied properties.

When the water is mixed with the dry concrete mixture, it can be shaped (typically poured or casted) and then solidified and hardened (cured, set) into rock-hard strength concrete through a chemical process called hydration. The water reacts with the cement, which bonds the other components together, finally creating a robust stone-like material.

During the setting of the freshly produced concrete, the Portland cement phases (calcium silicates, calcium aluminates and calcium aluminum ferrites) react with water to form cement stone (calcium silicate hydrates, calcium aluminum hydrates and calcium aluminum ferrite hydrates). The hydration process leads to crystal formation as well as the formation of calcium hydroxide. The crystallization caused by the presence of water leads to the formation of voids in the cement stone, which typically forms about 3% of the volume of the hardened concrete. Those voids are generally partly connected which allows that gas and liquids are able to penetrate the concrete.

Apart from the possibility to have different concrete formulations providing varied properties, there is also a distinction between unreinforced and reinforced concrete. Typically, steel rebars are used to reinforce concrete. Those rebars are protected by the alkalinity (high pH value level) of the pore water in the concrete, due to the high concentration of calcium hydroxide therein. The rebars are necessary to bear tensile forces and are essential for instance in order to cope with the bending of concrete beams.

The mechanism that destructs steel reinforced concrete that is exposed to humidity is called carbonation. In this carbonation process, carbon dioxide or CO₂ migrates into the concrete via the voids, where it reacts with Ca(OH)₂ to CaCO₃ (lime stone). This causes a reduction in pH value. For the concrete itself, this is not a problem, but for the reinforcement it is. The reinforcement that is normally made of steel is affected by acidity. Consequently, a corrosive environment is created for the reinforcing steel. The consequence thereof is that the reinforcement fails and ultimately leads to the loss of the integrity of the structure of the reinforced concrete or spalling of the concrete.

This carbonation is however a slow process. The carbonation front moves through the concrete starting at the surface. The concrete layer separating the reinforcement from the ambient atmosphere has to have a certain thickness, given in Euro Code 2 or other guidelines depending on surrounding conditions. The reaction velocity increases with the porosity, as CO₂ can more easily diffuse into the concrete and react with Ca(OH)₂.

In order to solve this problem, typically coatings are applied. The term “coating” is often used broadly to refer to just about any liquid or semi-solid material applied to cured concrete, including cement-based toppings and overlays, paints, and epoxy-aggregate systems. Concrete sealers are applied to concrete to protect it from surface damage, corrosion, and staining. They either block the pores in the concrete to reduce absorption of water and salts or form an impermeable layer which prevents such materials from passing. An example of a concrete sealer is a topical sealer that can provide visual enhancement of the top layer of the concrete as well as topical protection from stains and chemicals. They require a dry and clean surface during application to gain adhesion. Another example of a concrete sealer is a penetrating sealer, such as silane or siloxane, that can be applied to dry or damp concrete surfaces. It is important that the penetrating sealers are properly matched with substrate porosity in order to effectively penetrate the concrete surface and react. The chemical reaction bonds active ingredients within the substrate blocking surface moisture. Other examples of coatings that are applicable to the concrete surface are topical film membranes such as acrylic resins and epoxy/urethane systems.

The disadvantage of all above described coatings is that they have a limited lifespan and they only protect a layer concrete situated close to the upper surface of the concrete. The highest concentration of the coating remains close to the surface. In case of destruction of this layer, for instance by chemical or physical impact, the protection gets lost.

As an alternative to coatings, cements that increase the density and reduce the porosity of the concrete can be used. An example thereof is ground granulated blast furnace slag cements (CEM III), what usually leads to a prolonged curing process and consequently is time and money consuming.

Another alternative is to add silica fume to the concrete, targeting the density and the porosity of the concrete. Such concretes however suffer from the disadvantage that they are more brittle and tend to get cracks when exposed to bending.

Still another alternative is to apply thicker concrete cover layers. However, also these layers tend to crack, especially under bending loads.

Out of the above, it can be concluded that currently, no successful solutions are known that maintain the common properties of the concrete and in the meantime prevent carbonation of concrete by an in-concrete solution. Therefore, there exists the need to provide a solution that meets these requirements.

### SUMMARY OF THE APPLICATION

According to an aspect of the application, the use of calcium nitrate to modify the pore size distribution of a cementitious composition is disclosed, wherein the cementitious composition comprises between 1 weight % to 4 weight % of calcium nitrate of the cement content (or by weight of cement) of the cementitious composition, depending on the type of cement.

According to a particular use according to the application, the cementitious composition is a concrete composition.

A void observed in a hardened concrete composition typically has a void diameter anywhere between 10 μm to 3000 μm. Although the pore size size distribution depends on several factors, such as the type of cementitious composition, the preparation and casting method, environmental conditions, and so on, on average an increased density of pores will be observed having a pore size of approximately 100 μm and of approximately 1000 μm. The total air void content in the entire volume of the cementitious composition then defines the porosity of the composition.

The modification of the pore size distribution of the hardened cementitious composition by adding calcium nitrate means that more smaller and less bigger voids in the hardened cementitious composition are obtained. It has been surprisingly found that adding a specific amount of calcium nitrate, depending on the type of cement used in the cementitious composition, obtains this effect. In this way, the permeability of the hardened cementitious composition for carbon dioxide (CO₂) is reduced. It is remarked that, although the pore size distribution of the hardened cementitious composition is altered, the porosity of the concrete solid however hardly changes.

In general, it is observed that the addition of calcium nitrate causes the void size distribution to shift towards the sub-300 μm range, in particular sub-150 μm range and more in particular sub-100 μm range; that is, the total of amount of voids with a void size below respectively 300, 150 and/or 100 μm increases while the total of amount of voids with a void size above respectively 300, 150 and/or 100 μm decreases by the same amount.

The void size distribution shift results in an increase of at least 5% to at most 50% in void count in the range from least 30 μm to at most 300 μm. The shift is more pronounced in the range from at least 50 to at most 150 μm, wherein an increase of at least 10% to at most 50% is observed. The shift is especially prominent in the range of 60 to 100 μm, wherein an increase is observed from at least 20% to at most 50%.

In a further aspect according to the application, calcium nitrate is used to increase the density of voids with a void diameter below 300 μm, particularly below 150 μm, most particularly below 100 μm by at least 10%; particularly at least 20%; more particularly at least 30%; most particularly at least 40%.

Calcium nitrate is in particular used to increase the density of voids with a void diameter ranging from at least 30 μm to at most 300 μm by at least 5% to at most 50%; particularly at least 10% to at most 50%; more in particular at least 20% to at most 45%; most in particular at least 30% to at most 45%.

More particularly, calcium nitrate is used to increase the density of voids with a void diameter ranging from at least 50 μm to at most 150 μm by at least 5% to at most 50%; particularly at least 10% to at most 50%; more in particular at least 20% to at most 45%; most in particular at least 30% to at most 45%.

Most in particular, calcium nitrate is used to increase the density of voids with a void diameter ranging from at least 60 μm to at most 100 μm by at least 5% to at most 50%; particularly at least 10% to at most 50%; more in particular at least 20% to at most 45%; most in particular at least 30% to at most 45%.

The article “Effect of calcium nitrate on the freeze-thaw-resistance of concrete”, published in the proceedings of the 2^{nd} International Congress on Durability of Concrete as paper no. 8, 4.-6.12.2014, New Delhi, India by Franke et al. (2014) already described in a study the effect that at the presence of calcium nitrate, the crystallization of the cementitious composition seems to be slightly changed from fewer large voids to more small voids. The study however did not evaluate the permeability and consequently void interlinks in a hardened cementitious composition that are responsible for the permeability.

It could now also be observed that calcium nitrate not only modifies the pore size distribution but also the void links and thus the permeability of the hardened cementitious composition. This results in limiting the gas migration, here carbon dioxide, as well as liquid migration, here hydrocarbon acid, into the hardened cementitious composition, more specific concrete.

According to the experiments as discussed in more detail further in this patent application, a reduction of the carbonation depth in the hardened cementitious composition of up to 40% are obtainable.

As a result of this modification of the pore size distribution, when such cementitious composition including calcium nitrate is used as a basis for steel reinforced concrete solid, the resistance towards the carbonation frontier of the hardened cementitious composition, or in other words the migration of carbon dioxide and the dissolution in water to form hydrocarbon acid, in the concrete solid is increased. In this way, the carbonation induced corrosion of the hardened concrete is reduced.

Particularly, the concrete composition comprises 300-500 kg cement per m³ hardened concrete, more in particular Portland cement.

More in particular, an amount of the cement is replaced by a cement replacement material at a concentration of between 0.1 weight % to 50 weight % of the cement content of the cementitious composition.

The cement replacement material is more in particular chosen out of any one of fly ash, ground granulated slag, lime stone or a combination thereof.

The concrete composition particularly comprises 150-300 kg water per m³ hardened concrete.

In particular, the concrete composition comprises between 1.500-1.800 kg aggregate per m³ hardened concrete.

More particularly, the aggregate comprises sand, gravel and stones.

According to a further aspect of the application, a method for producing a cementitious composition having a modified pore size distribution after being set is disclosed, wherein the method comprises the step of including between 1 weight % to 4 weight % of calcium nitrate of the cement content of the cementitious composition, depending on the type of cement, into the cementitious composition.

In a possible method according to the application, the cementitious composition is a concrete composition.

The method particularly comprises the step of including between 300 and 500 kg Portland cement per m³ hardened concrete into the concrete composition.

More particularly, the method comprises the step of replacing an amount of Portland cement by a cement replacement material at a concentration of between 0.1 weight % to 50 weight % of the cement content of the cementitious composition.

Most particularly, the cement replacement material is chosen out of any one of fly ash, ground granulated slag, lime stone or a combination thereof.

The method comprises more in particular the step of including between 150 and 300 kg water per m³ hardened concrete into the concrete composition.

Particularly, the method comprises the step of including between 1.500 and 1.800 kg aggregate per m³ hardened concrete into the concrete composition.

More preferably, the aggregate comprises sand, gravel and stones.

According to a further aspect of the application, a method for producing a cementitious composition having a modified pore size distribution after being set is disclosed, wherein the calcium nitrate increases the density of voids with a void diameter below 300 μm, particularly below 150 μm, most in particular below 100 μm by at least 10%; particularly at least 20%; more in particular at least 30%; most in particular at least 40%.

Calcium nitrate in particular increases the density of voids with a void diameter ranging from at least 30 μm to at most 300 μm by at least 5% to at most 50%; particularly at least 10% to at most 50%; more particularly at least 20% to at most 45%; most in particular at least 30% to at most 45%.

More in particular, calcium nitrate increases the density of voids with a void diameter ranging from at least 50 μm to at most 150 μm by at least 5% to at most 50%; particularly at least 10% to at most 50%; more in particular at least 20% to at most 45%; most in particular at least 30% to at most 45%.

Most particularly, calcium nitrate increases the density of voids with a void diameter ranging from at least 60 μm to at most 100 μm by at least 5% to at most 50%; particularly at least 10% to at most 50%; more in particular at least 20% to at most 45%; most in particular at least 30% to at most 45%.

According to a further aspect of the application, a pourable and curable (wet) concrete composition is disclosed, comprising per m³ cured concrete
between 300 and 500 kg cement;
between 150 and 300 kg water;
between 1.500 and 1.800 kg aggregate; and
between 1 weight % to 4 weight % of the cement content of the concrete composition, depending on the type of cement, of calcium nitrate.

In a possible concrete composition, an amount of cement is replaced by a cement replacement material at a concentration of between 0.1 weight % to 50 weight % of the cement content of the concrete composition.

In a particular embodiment of a concrete composition, the cement replacement material is chosen out of any one of fly ash, ground granulated slag, lime stone or a combination thereof.

Most in particular, the aggregate comprises sand, gravel and stones.

Most in particular, the cement is Portland cement.

It is remarked that, after water is added to a dry, cementitious (concrete) composition, consisting of the cement as the hinder, the aggregate and the calcium nitrate, and mixing it, a wet, pourable cementitious (concrete) composition is obtained.

According to a further aspect of the application, the use of calcium nitrate as an admixture for a steel reinforced concrete composition to increase the resistance towards carbonation of the steel reinforced hardened concrete is disclosed, wherein the concrete composition comprises cement and the calcium nitrate at a dosage of 1 weight % to 4 weight % of the of the cement content of the concrete composition.

In a more particular use, the concrete composition is one according to the application as disclosed above.

According to a further aspect of the application, the use of calcium nitrate as an admixture for a steel reinforced concrete composition to increase the density of voids with a void diameter below 300 μm, particularly below 150 μm, most in particular below 100 μm by at least 10%; particularly at least 20%; more in particular at least 30%; most in particular at least 40%.

Particularly, calcium nitrate is used to increase the density of voids with a void diameter ranging from at least 30 μm to at most 300 μm by at least 5% to at most 50%; particularly at least 10% to at most 50%; more in particular at least 20% to at most 45%; most in particular at least 30% to at most 45%.

Calcium nitrate is more in particular used to increase the density of voids with a void diameter ranging from at least 50 μm to at most 150 μm by at least 5% to at most 50%; particularly at least 10% to at most 50%; more in particular at least 20% to at most 45%; most in particular at least 30% to at most 45%.

Calcium nitrate is most in particular used to increase the density of voids with a void diameter ranging from at least 60 μm to at most 100 μm by at least 5% to at most 50%; particularly at least 10% to at most 50%; more in particular at least 20% to at most 45%; most in particular at least 30% to at most 45%.

According to a further aspect of the application, a steel reinforced concrete solid having an elevated resistance towards carbonation is disclosed that is obtained from curing the pourable and curable concrete composition according to the application as described above.

According to a final aspect of the application, a method for producing a steel reinforced concrete solid having an elevated resistance towards carbonation is disclosed, the method comprising the steps of:
I) preparing a concrete composition according to the application as described above comprising mixing the water, the cement, the aggregate and the calcium nitrate;
II) casting the concrete composition into a form provided with a steel reinforcement; and
III) having the concrete composition hardened into the steel reinforced concrete solid with the elevated resistance towards carbonation.

### BRIEF DESCRIPTION OF THE FIGURES

FIG. 1 shows a diagram wherein the carbonation depth in cm of two different cementitious compositions A and B under accelerated conditions is shown;

FIG. 2 shows a diagram wherein the carbonation depth in cm of two different cementitious composition A and B under normal atmospheric conditions is shown.

FIG. 3 shows a graph wherein the cumulative frequency in % is displayed in function of the void size in μm for three different cementitious compositions.

### DETAILED DESCRIPTION OF THE INVENTION

The present invention relates to the use of calcium nitrate to modify the pore size distribution of a hardened cementitious composition, more preferably a hardened concrete composition. A pore is the void space embedded within the solid matrix of a porous media, here the hardened cementitious composition, more specifically the hardened concrete (also called “set” or “cured” concrete). The porosity of a hardened concrete is the total pore volume. When the pore size distribution of the cementitious composition is modified versus known state of the art set cementitious compositions, i.e. more smaller and less bigger voids, the permeability of the hardened cementitious composition for carbon dioxide (CO₂) is reduced.

Depending on the type of cement, 1 weight % (also called mass percent) to 4 weight % of calcium nitrate by weight of cement (cement content of the cementitious composition) is included in the dry cementitious composition (before water is added). All types of calcium nitrate can be used such as calcium nitrate solution or calcium nitrate containing granules.

The pourable and curable cementitious composition, also called “wet” cementitious composition, preferably the wet, pourable and curable concrete composition, preferably comprises per m³ cured concrete:
300-500 kg cement, preferably Portland cement, which serves as the binder of the cementitious composition (concrete);
150-300 kg water;
1.500-1.800 kg aggregate, preferably sand (fine aggregate), gravel and stones (coarse aggregate);
1 weight % to 4 weight % of calcium nitrate by weight of cement.

It is remarked that, after water is added to the dry, cementitious (concrete) composition consisting of the binder, the aggregate and the calcium nitrate as an admixture, and mixing the water with this dry, cementitious (concrete) composition, a pourable and curable, wet cementitious (concrete) composition is obtained that sets after a certain period of time.

The invention also relates to a method for producing a cementitious composition resulting in a set cementitious composition having a reduced pore size distribution. This method comprises the step of including between 1 weight % to 4 weight % of calcium nitrate by weight of cement, depending on the type of cement used.

The method preferably furthermore comprises the steps of including in the cementitious (concrete) composition:
300-500 kg cement, preferably Portland cement, which serves as the binder of the cementitious composition (concrete);
150-300 kg water; and
1.500-1.800 kg aggregate, preferably sand (fine aggregate), gravel and stones (coarse aggregate).

Depending on the application and thus the required properties of the concrete, stones such as amongst others crushed rocks such as limestone or granite can be used.

It is possible to replace 0.1 weight % to 50 weight % of the cement by a cement replacement material such as fly ash, ground granulated slag, lime stone or any combination thereof.

The invention furthermore relates to the use of calcium nitrate as an admixture for a steel reinforced concrete composition to increase the resistance towards carbonation of the steel reinforced hardened concrete, wherein the concrete composition comprises cement and the calcium nitrate at a dosage of 1 to 4 weight % of the cement weight.

It has been observed that, when the pore size distribution of the concrete solid is altered by adding a certain amount of calcium nitrate, an increase of the resistance towards the carbonation frontier of the steel reinforced concrete solid is obtained. In other words, the migration of carbon dioxide and the dissolution in water to form hydrocarbon acid, in the steel reinforced concrete, is increased.

The invention also relates to a method for producing a steel reinforced concrete solid having an elevated resistance towards carbonation, comprising the steps of:
(I) preparing a concrete composition according to the invention as disclosed above comprising mixing the water, the cement, the aggregate and the calcium nitrate;
(II) casting the concrete composition into a form provided with a steel reinforcement; and
(III) having the concrete composition hardened into the steel reinforced concrete solid with the elevated resistance towards carbonation.

The invention finally relates to a steel reinforced concrete solid obtained from hardening the concrete composition according to the invention as disclosed above.

### EXAMPLES

### Example 1: Accelerated Tests

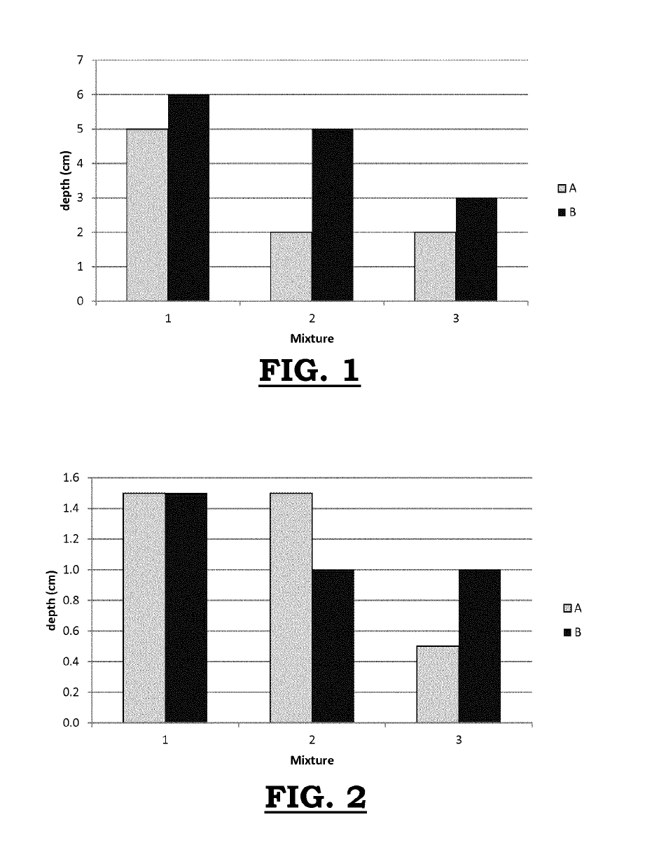

In a first case study, the carbonation in a number of concrete samples under accelerated conditions was studied. The samples were prepared with a water to cement ratio of 0.5. Two types of cement were used, i.e. CEM I 42.5 R (A) and CEM II/A-V 42.5 R (B). The dosage levels of calcium nitrate were 0 weight % (1), 1 weight % (2) and 2 weight % (3). The samples were cured for a period of 28 days and afterwards exposed to an atmosphere with 2% CO₂ until 56 days. After 56 days, analysis of the carbonation depth was performed. In FIG. 1, a diagram is shown that shows the carbonation depth in average goes down. For CEM I, the carbonation depth is already minimized when using a 1 weight % calcium nitrate dosage, while for CEM II/V-A the carbonation depth is minimized when using 2 weight % calcium nitrate dosage.

### Example 2: Non-Accelerated Tests

In a second case study, the carbonation in a number of concrete samples under normal conditions was studied. The samples were prepared with a water to cement ratio of 0.5. Two types of cement were used, i.e. CEM I 42.5 R (A) and CEM II/A-V 42.5 R (B). The dosage levels of calcium nitrate were 0 weight % (1), 1 weight % (2) and 2 weight % (3). The samples were cured for a period of 28 days and afterwards exposed to ordinary atmosphere until 182 days. After 182 days, analysis of the carbonation depth was performed. In FIG. 2, a diagram is shown that shows that the carbonation depth in average goes down. For CEM I, the carbonation depth is already minimized when using a 2 weight % calcium nitrate dosage, while for CEM II/V-A the carbonation depth is minimized age.

### Example 3: Void Size Distribution Tests

In a third case study, the effect of calcium nitrate on the void size distribution in a number of concrete samples was studied. The samples were prepared with a water to cement ratio of 0.5. The concrete compositions contained Ordinary Portland cement (OPC). Three reinforced concrete samples were prepared in cubes with an edge length of 150 mm.

The first and the second sample served as comparative reference values; in particular reference A contained a cementitious composition without any additives, while reference B contained a cementitious composition with a porosity increasing additive (e.g. admixture of surfactants) commonly used in the art. The third sample contained the composition of reference B together with 4 weight % of calcium nitrate by weight of cement.

Measurement of the total air void content indicated that the sample with 4% calcium nitrate lead to the highest porosity value of 6.0%; however, the 0.2% increment over the reference B porosity value of 5.8% was regarded as negligible. It is therefore concluded that the addition of calcium nitrate has almost no discernible effect on the porosity of reinforced concrete.

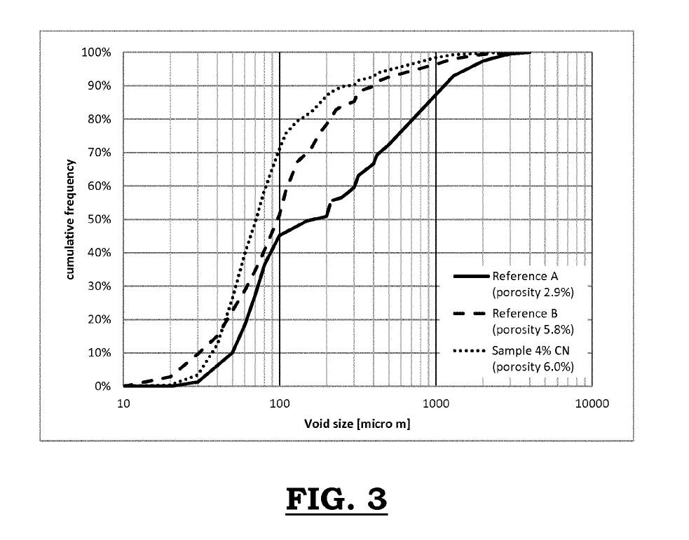

In contrast, measurements of the air void size distribution presented in FIG. 3 did display significant differences between the calcium nitrate sample and the two reference samples.

In general the addition of calcium nitrate caused the total number of voids with a void diameter below 300 μm to increase, while simultaneously causing the total number of voids with a void diameter above 300 μm to decrease; thus obtaining an effective void size shift to lower void sizes (i.e. to the left on FIG. 3) after addition of calcium nitrate. The formerly described shift becomes even more pronounced below 150 μm, and is especially prominent below 100 μm.

When focusing on the cut-off value of 100 μm in the sample containing 4% calcium nitrate, approximately 71% of voids now have a void diameter of 100 μm or less, while approximately 29% of voids to have a diameter above 100 μm. In comparison, at the same cut-off value for reference B, only 51% of voids have a void diameter below 100 μm, and for reference A this value even decreases to 45%. It is therefore concluded that the addition of calcium nitrate causes the void size distribution to shift by approximately 39% towards the sub-100 μm range; that is, the total of amount of voids with a void size below 100 μm increases by 39%, while the total of amount of voids with a void size above 100 μm decreases by the same amount.

Similar observations are noticeable at different cut-off value of the void diameter, and are presented below in Table 1, which shows an overview of the void size distribution ranges at selected cut-off values of 30, 50, 60, 70, 80, 100, 300, 1000 and 2000 μm.

A similar comparison can then be made between samples with the similar porosity values; namely reference B and the sample with 4% wt. calcium nitrate. The results are presented in Table 2.

In general it is found that the effect of calcium nitrate is already noticeable from 30 μm onwards, wherein the total number of voids increases by ˜40% (i.e. approximation due to the low number of voids with a diameter of 30 μm or below) up to 300 μm, wherein the total number of voids increases by 6%.

TABLE 1
Void size distribution ranges

| Cut-off value | Reference A | Reference B | Sample 4% CN |
|---|---|---|---|
| x (in μm) | (porosity 2.9%) | (porosity 5.8%) | (porosity 6.0%) |
| 30 | 1% ≤ x < 99% | 3% ≤ x < 97% | 5% ≤ x < 95% |
| 50 | 10% ≤ x < 90% | 23% ≤ x < 90% | 26% ≤ x < 74% |
| 60 | 18% ≤ x < 82% | 29% ≤ x < 71% | 40% ≤ x < 60% |
| 70 | 27% ≤ x < 73% | 35% ≤ x < 90% | 49% ≤ x < 51% |
| 80 | 36% ≤ x < 64% | 40% ≤ x < 60% | 58% ≤ x < 42% |
| 100 | 45% ≤ x < 55% | 51% ≤ x < 49% | 71% ≤ x < 29% |
| 150 | 50% ≤ x < 50% | 69% ≤ x < 31% | 81% ≤ x < 19% |
| 300 | 60% ≤ x < 40% | 85% ≤ x < 15% | 90% ≤ x < 10% |
| 1000 | 87% ≤ x < 13% | 96% ≤ x < 4% | 98% ≤ x < 2% |
| 2000 | 97% ≤ x < 3% | 100% ≤ x | 100% ≤ x |

TABLE 2
Comparative increment in void size amount

| Cut-off value | Reference B | Sample 4% CN | Relative |
|---|---|---|---|
| x (in μm) | (porosity 5.8%) | (porosity 6.0%) | increment |
| 30 | 3% < x | 5% < x | ~40% |
| 50 | 23% < x | 26% < x | 13% |
| 60 | 29% < x | 40% < x | 37% |
| 70 | 35% ≤ x | 49% ≤ x | 40% |
| 80 | 40% ≤ x | 58% ≤ x | 45% |
| 100 | 51% ≤ x | 71% ≤ x | 39% |
| 150 | 69% ≤ x | 81% ≤ x | 17% |
| 300 | 85% ≤ x | 90% ≤ x | 6% |
| 1000 | 96% ≤ x | 98% ≤ x | 2% |
| 2000 | 100% ≤ x | 100% ≤ x | 0% |

However, the effect becomes clearly defined in the range of 50 to 150 μm, wherein the calcium nitrate shows an effective increase in void count by at least 13%; especially in the range of 60 to 100 μm the void count is observed to increase drastically by at least 37%. The highest void increment of 45% is observed for a void diameter of 80 μm.

After 300 μm the three samples are observed to equalize in the total number of voids, thus indicating that the total number of voids with a void diameter above 300 μm were reduced by the same amounts as previously reported and the total porosity is confirmed to remain unaffected by calcium nitrate.

In conclusion, the addition of 4% wt. calcium nitrate to the third sample caused the total number of voids with a void diameter below 300 μm to increase, in particular below 150 μm, more in particular below 150 μm; while simultaneously causing the total number of voids with a void diameter above respectively 300, 150 and/or 100 μm to decrease. As a result, the overall porosity of the hardened cementitious composition remained approximately similar, that is bringing about only discernible changes to the overall porosity, yet the pore size distribution was modified significantly.

1-12. (canceled)

13. Method for producing a cementitious composition having a modified pore size distribution after being set, CHARACTERISED IN THAT the method comprises the step of including between 1 weight % to 4 weight % of calcium nitrate of the cement content of the cementitious composition, depending on the type of cement, into the cementitious composition, wherein calcium nitrate increases the density of voids with a void diameter below 300 μm by at least 10%.

14. Method according to claim 13, wherein the cementitious composition is a concrete composition.

15. Method according to claim 14, wherein the method comprises the step of including between 300 and 500 kg Portland cement per m³ hardened concrete into the concrete composition.

16. Method according to claim 14, wherein the method comprises the step of replacing an amount of cement by a cement replacement material at a concentration of between 0.1 weight % to 50 weight % of the cement content of the cementitious composition.

17. Method according to claim 16, wherein the cement replacement material is chosen out of any one of fly ash, ground granulated slag, lime stone or a combination thereof.

18. Method according to claim 13, wherein the method comprises the step of including between 150 and 300 kg water per m³ hardened concrete into the concrete composition.

19. Method according to claim 13, wherein the method comprises the step of including between 1.500 and 1.800 kg aggregate per m³ hardened concrete into the concrete composition.

20. Method according to claim 19, wherein the aggregate comprises sand, gravel and stones.

21. Method according to claim 13, wherein calcium nitrate increases the density of voids with a void diameter below 300 μm by at least 20%; more preferably at least 30%; most preferably at least 40%.

22. Method according to claim 13, wherein calcium nitrate increases the density of voids with a void diameter ranging from at least 30 μm to at most 300 μm by at least 5% to at most 50%; preferably at least 10% to at most 45%; more preferably at least 20% to at most 45%; most preferably at least 30% to at most 45%.

23. Method according to claim 13, wherein calcium nitrate increases the density of voids with a void diameter ranging from at least 50 μm to at most 150 μm by at least 5% to at most 50%; preferably at least 10% to at most 45%; more preferably at least 20% to at most 45%; most preferably at least 30% to at most 45%.

24. Method according to claim 13, wherein calcium nitrate increases the density of voids with a void diameter ranging from at least 60 μm to at most 100 μm by at least 5% to at most 50%; preferably at least 10% to at most 45%; more preferably at least 20% to at most 45%; most preferably at least 30% to at most 45%.

25. Pourable and curable concrete composition, comprising per m³ cured concrete
between 300 and 500 kg cement;
between 150 and 300 kg water;
between 1.500 and 1.800 kg aggregate; and
between 1 weight % to 4 weight % of the cement content of the concrete composition, depending on the type of cement, of calcium nitrate.

26. Concrete composition according to claim 25, wherein an amount of cement is replaced by a cement replacement material at a concentration of between 0.1 weight % to 50 weight % of the cement content of the concrete composition.

27. Concrete composition according to claim 26, wherein the cement replacement material is chosen out of any one of fly ash, ground granulated slag, lime stone or a combination thereof.

28. Concrete composition according to claim 25, wherein the aggregate comprises sand, gravel and stones.

29. Concrete composition according to claim 27, wherein the cement is Portland cement.

30-35. (canceled)

36. Steel reinforced concrete solid having an elevated resistance towards carbonation obtained from hardening the concrete composition according to claim 25.

37. Method for producing a steel reinforced concrete solid having an elevated resistance towards carbonation, comprising the steps of:
(I) preparing a concrete composition according to claim 25 comprising mixing the water, the cement, the aggregate and the calcium nitrate;
(II) casting the concrete composition into a form provided with a steel reinforcement; and
(III) having the concrete composition hardened into the steel reinforced concrete solid with the elevated resistance towards carbonation.
